(19) United States
(12) Patent Application Publication
(10) Pub. No.: US 2010/0068923 A1
(43) Pub. Date: Mar. 18, 2010

(54) SIDE MOUNTED PATCH PANEL

(76) Inventor: Edouard TABET, Brossard (CA)

Correspondence Address: GOUDREAU GAGE DUBUC, 2000 MCGILL COLLEGE, SUITE 2200, MONTREAL, QC, H3A 3H3, CA

(21) Appl. No.: 12/552,608

(22) Filed: Sep. 2, 2009

Related U.S. Application Data
(60) Provisional application No. 61/093,557, filed on Sep. 2, 2008.

(51) Int. Cl. H01R 13/60

(52) U.S. Cl. 439/540.1

(57) ABSTRACT

A patch panel for mounting to a telecommunications rack comprising a pair of spaced vertical rails. The patch panel comprises a base frame comprising a mounting plate for attachment to one of the pair of rails and upper and lower elongate brackets extending away from an edge of the mounting plate at an angle thereto, the upper and lower brackets substantially parallel and spaced to define an open-ended connector receiving slot therebetween, at least one connector module, each of the at least one module comprising a plug receiving socket on a front face thereof, a latch arm on an upper surface thereof and a retaining rib on a lower surface thereof, wherein when the at least one connector module is positioned in the slot, the latch arm engages an inner edge of the upper bracket and the retaining rib engages an inner edge of the lower bracket thereby retaining the connector module within the slot, and a cover comprising a locking mechanism for releasably locking to the base frame over the at least one connector module, the cover comprising at least one aperture on a front face thereof, each of the at least one aperture providing access to the plug receiving socket of a respective one of the at least one connector.

### CROSS REFERENCE TO RELATED APPLICATIONS

This application claims priority, under 35 U.S.C. §119(e), of U.S. provisional application Ser. No. 61/093,557, filed on Sep. 2, 2008 which is incorporated herein in its entirety by reference.

### FIELD OF THE INVENTION

The present invention relates to a side mounted patch panel. In particular, the present invention relates to a patch panel suitable for mounting on the side of a networking rack or cabinet to increase capacity.

### BACKGROUND OF THE INVENTION

As known in the art, local area networks and telecommunications connections often use patch panels installed on networking cabinets or racks to enable connection between various telecommunications equipment. Horizontal patch panels are typically arranged horizontally at the top of the networking racks and usually take up about one rack unit per 24 ports of connection. As a result, such patch panels compromise density and are space consuming. Vertical patch panels on the other hand are typically mounted vertically on networking racks to reduce cable lengths, increase port density, simplify layouts and provide aesthetic benefits due to cabling symmetry, thus reducing overall costs. However, a major drawback of most of these patch panels is that they require connector installation or maintenance to be performed from the back of the patch panel in addition to impeding the installer's access to connector ports once the patch panel is mounted to the networking rack.

What is therefore needed, and an object of the present invention, is an improved patch panel, which increases port density while simplifying installation and maintenance and significantly saving space within the networking cabinet or rack.

### BRIEF DESCRIPTION OF THE DRAWINGS

In the appended drawings:

FIG. 1 is a front perspective view of a side mounted patch panel mounted on a telecommunications rack in accordance with an illustrative embodiment of the present invention;

FIG. 2 is an exploded perspective view of the side mounted patch panel of FIG. 1 in accordance with an illustrative embodiment of the present invention;

FIG. 3 is an exploded perspective view of the patch panel base of the side mounted patch panel of FIG. 1 in accordance with an illustrative embodiment of the present invention;

FIG. 4A is a perspective view indicating the method of assembly of side mounted patch panel of FIG. 2;

FIG. 4B is an end plan view of the side mounted patch panel of FIG. 4A; and

FIG. 5 is a perspective view of the patch panel front cover of the side mounted patch panel of FIG. 1 mounted to the patch panel base and connectors of FIG. 4.

### DESCRIPTION OF ILLUSTRATIVE EMBODIMENTS

The present invention is illustrated in further details by the following non-limiting examples.

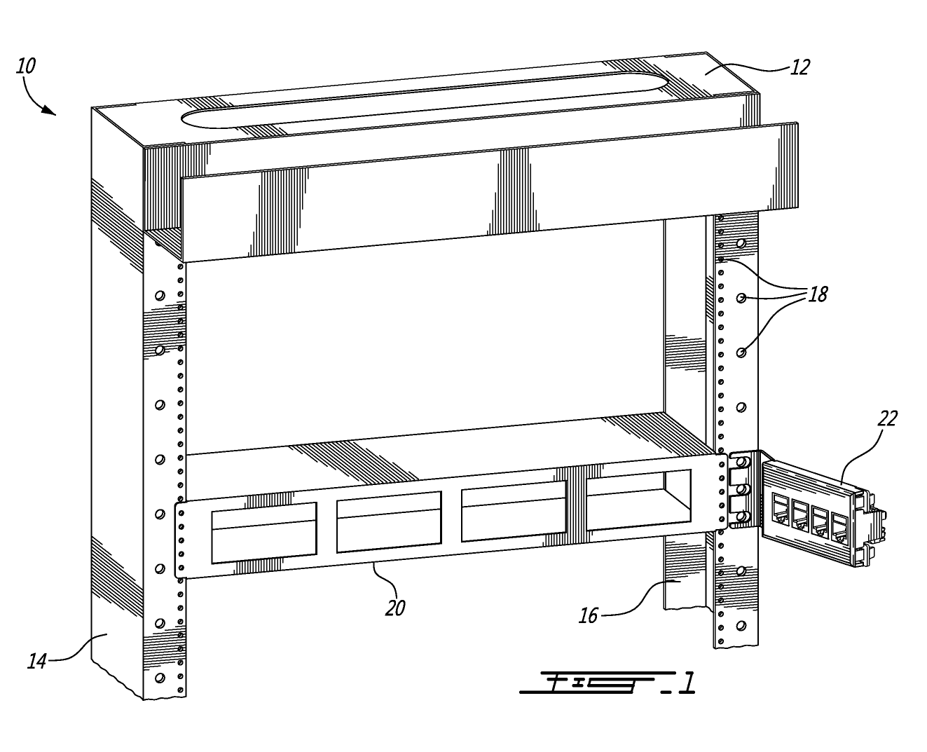

Referring now to FIG. 1, and in accordance with an illustrative embodiment of the present invention, a patch panel assembly, generally referred to using the reference numeral 10, will now be described. The patch panel assembly 10 illustratively comprises a standard network rack 12 (e.g. EIA/TIA 19-inch rack) comprising two (2) spaced vertical side rails 14 and 16 extending along a common vertical plane. Each rail 14 and 16 comprises a plurality of apertures as in 18 for mounting thereon a plurality of rack-mounted equipment 20 (e.g. servers managing network resources) through the use of fasteners such as nuts, bolts, and the like (not shown). The patch panel assembly 10 further has mounted thereon via fasteners a side mounted patch panel 22, which advantageously increases the density of the patch panel assembly 10, as will be discussed further herein below.

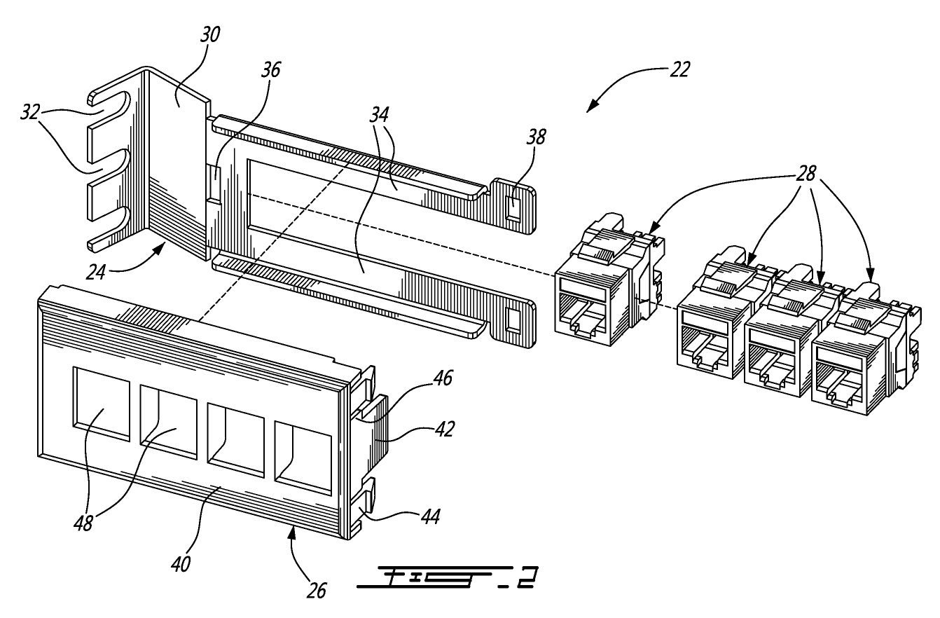

Referring now to FIG. 2 in addition to FIG. 1, the patch panel 22 illustratively comprises a patch panel base frame 24, a patch panel front cover 26 and a plurality of connector modules as in 28 of various types, such as fiber or copper, that allow for the configuration of large cross-connect systems and interconnect rack-mounted systems as in 20 on the network rack 12. For the purpose of mounting the patch panel 22 to the rail 14 or 16 of the network rack 12, the patch panel base 24, which is illustratively made of steel, plastic, or some other suitable rigid material, comprises a mounting plate 30 (illustratively L-shaped) formed integrally therewith. The mounting plate 30 has a plurality of mounting apertures as in 32, which are sized to be mated with the apertures as in 18 provided on each rail 14, 16. The patch panel base 24 is further formed of an upper and a lower elongate bracket as in 34 extending substantially parallel and at an angle to an edge of the mounting plate 30, with an open-ended slot (not shown) being defined between the brackets as in 34.

Still referring to FIG. 2, to enable attachment of the patch panel front cover 26 to the patch panel base 24, an aperture 36 is illustratively formed in the patch panel base 24 adjacent the mounting plate 30 (illustratively at a connection between the mounting plate 30 and the brackets 34) and a pair of apertures as in 38 provided at the extremity of each bracket 34. The patch panel front cover 26 further comprises a substantially flat cover plate 40 with a tab 42 and a pair of raised insertion tabs as in 44 projecting from a first edge thereof at substantially right angles thereto. The tab 42 is illustratively sized to fit and be retained (via stops as in 46) within the spacing between the brackets as in 34 while the insertion tabs as in 44 are adapted to be inserted within the apertures as in 38 and received therein. An additional insertion tab (not shown) further projects substantially at a right angle to a second edge of the plate 40 opposite the tab 42 and the insertion tabs as in 44 and is adapted to be received into the aperture 36. Using this locking mechanism, the patch panel front cover 26 is snap-fitted and thus locked in place relative to the patch panel base 24. A plurality of openings as in 48 is further formed in the plate 40 of the patch panel front cover 26 to provide access to a front face of the connectors as in 28 received in the patch panel base 24 when the patch panel 22 is assembled (as discussed further herein below), thus enabling termination of cables (not shown) subsequently connected to the patch panel 22.

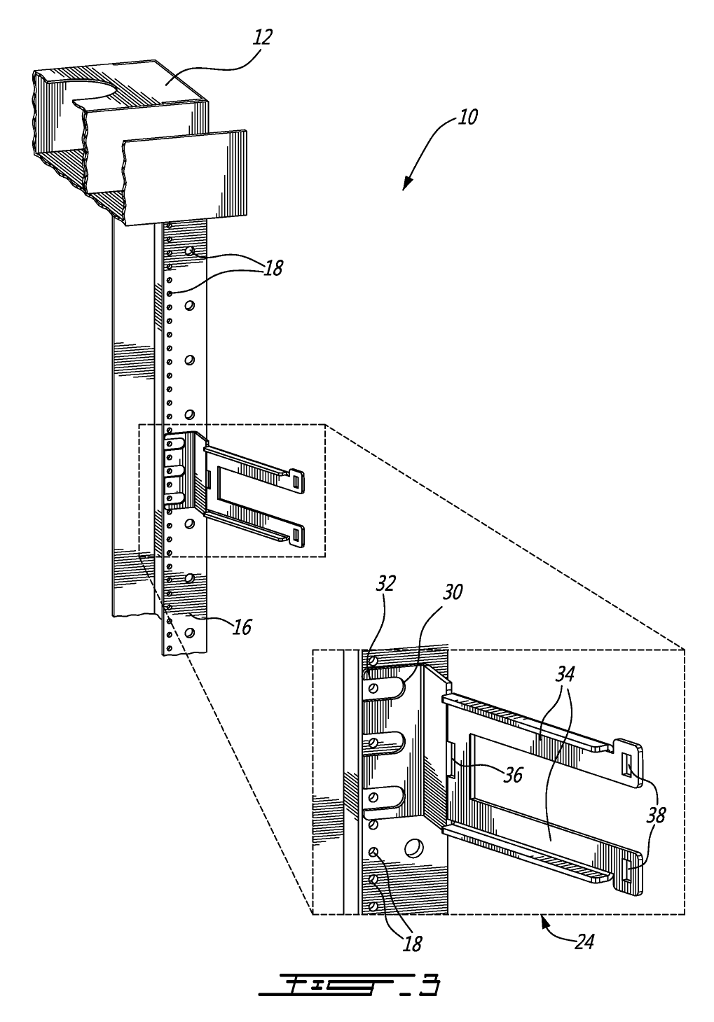

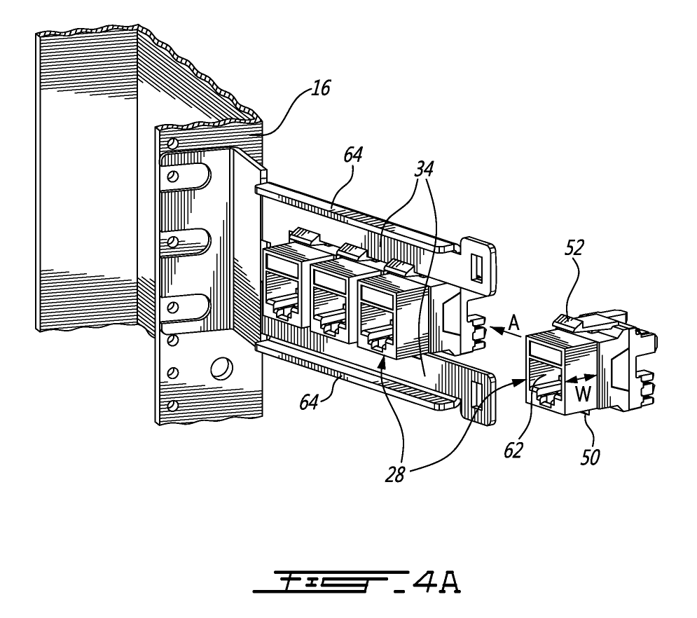

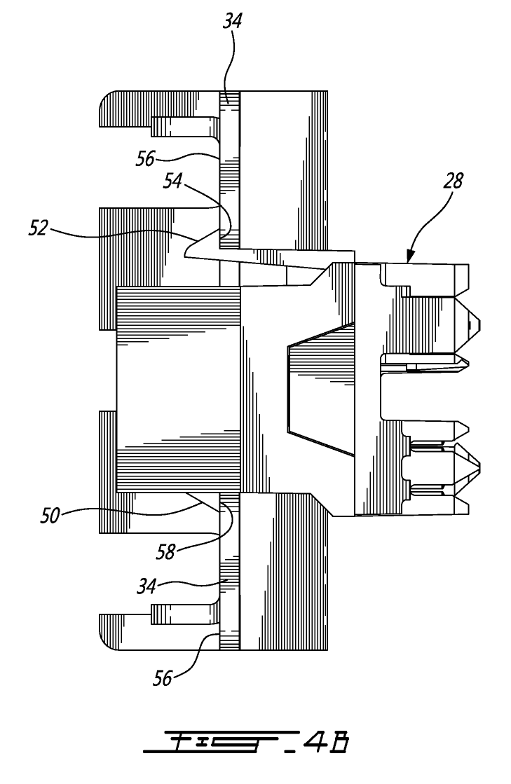

Referring now to FIG. 3 and FIG. 4A, during installation, the patch panel base 24 is illustratively initially mounted to one of the rails as in 14, 16 of the network rack 12 by aligning the mounting apertures as in 32 of the mounting plate 30 with the apertures as in 18 of the rail 16. A fastener (e.g. a screw, nut, and bolt combination, or the like, not shown) is then inserted into the aligned apertures 18 and 32 to attach the patch panel base 24 to the rail 16 in a conventional manner. As illustrated, the thus mounted patch panel base 24 projects away from the rail 16 at an angle (illustratively an obtuse angle) thereto. Once a connector 28 is terminated, it is mounted to the patch panel base 24 by sliding the connector 28 in the direction of arrow A within the open-ended slot formed between the brackets as in 34 along inner edges (not shown) of the brackets as in 34 adjacent the slot. For this purpose, the spacing between the brackets as in 34 is designed to match the size of each connector 28 such that once slid therein, the connector 28 is securely retained within the slot of the patch panel base 24. Illustratively, up to four (4) connectors can be held by a single patch panel (reference 22 in FIG. 1).

Referring now to FIGS. 4A and 4B, in the illustrated particular connector model each connector 28 comprises a retaining rib 50 and a flexible cantilevered latch arm 52 which engage respective inner edges of the brackets as in 34 as the connector 28 is being installed. The stop surface 54 of the cantilevered latch arm 52 abuts against a front face 56 of the upper bracket 34 while the stop surface 58 of the retaining rib 50 provided on a lower surface of the connector 28 abuts against a front face 56 of the lower bracket 34, thus retaining the connector 28 in place within the slot defined by the brackets as in 34. As a result, pulling on the connector 28 in a direction perpendicular to the longitudinal axis (not shown) of the patch panel base 24 is prevented from removing the connector 28, which can instead be uninstalled by sliding movement in a direction opposite to that of arrow A.

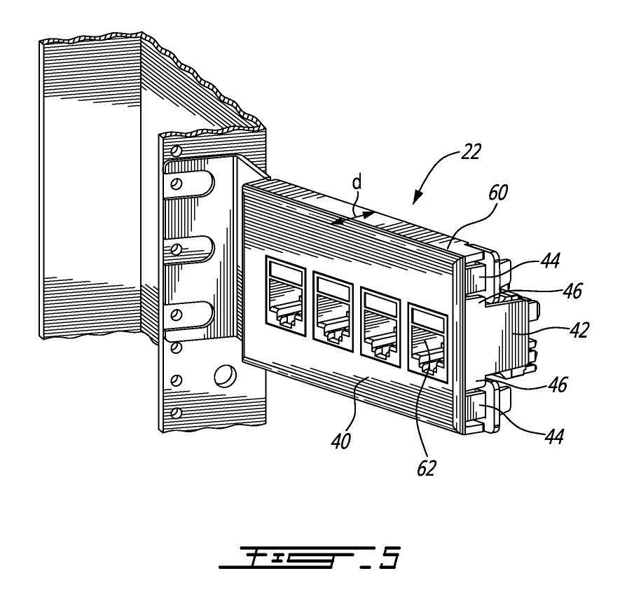

Referring now to FIG. 5 in addition to FIG. 4A, the patch panel front cover 26 is then mounted, as discussed herein above, to the patch panel base 24 over the connectors as in 28 in order to align and better retain the latter in place. When the patch panel 22 is assembled, it is desirable for the plate 40 of the patch panel front cover 26 to be spaced from the brackets as in 34 by a distance d in order to properly accommodate the connectors as in 28. For this purpose, an upper and a lower strip as in 60 having a width d substantially equal to the width W of a forward portion (not shown) of each connector 28 are formed integrally with the plate 40 and project rearwardly from an upper and a lower edge thereof at a substantially right angle. This ensures that, once the patch panel front cover 26 is mounted to the patch panel base 24, most if not the entirety of the forward portion of each connector 28 is accommodated within the patch panel front cover 26. As a result, a front face (not shown) of the connector can be substantially flush with (or alternatively can slightly recess or protrude from) the plate 42 so that a cable plug receiving opening or socket 62 moulded on the front face of each connector 28 and adapted to receive a mating cable plug (not shown) remains readily accessible from the front of the patch panel 22 through a corresponding one of the apertures (reference 46 in FIG. 2) formed in the plate 40.

Still referring to FIG. 5 in addition to FIG. 4A, in order to more securely attach the patch panel front cover 26 to the patch panel base 24, the patch panel base 24 is illustratively provided with an upper and a lower strip as in 64 integrally formed with the brackets as in 34 and projecting frontwardly therefrom at a substantially right angle. When the patch panel front cover 26 is mounted to the patch panel base 24, each one of the strips as in 60 engages and abuts against a corresponding one of the strips as in 64 to better hold the assembly in place. It will now be apparent that the snap-fit design of the patch panel 22 allows for the latter to be easily disassembled at any time. The patch panel front cover 26 can indeed be conveniently uninstalled for maintenance purposes or to add one or more connectors as in 28 to the patch panel 22 and thus increase port density.

Referring back to FIG. 1, the patch panel 22 illustratively utilizes zero rack unit (0U) on the network rack 12 as it does not occupy any valuable rack space (unlike, for example, horizontal patch panels, not shown, which typically take up two (2) or more rack units) and can be advantageously removed from the network rack 12 altogether. As a result, significant space savings are achieved. In addition, it may be possible to cover more height on the network rack 12 (e.g. 2U and more) by stacking a plurality of patch panels as in 22 one on top of the other to cover a desired height. The patch panel 22 can therefore be adapted for use with a variety of already existing telecommunications equipment 20. Moreover, when mounted to a rail 14 or 16 of the network rack 12, the patch panel 22 projects from the side thereof at an angle (illustratively obtuse) to the rail 14 or 16. In this manner, the patch panel 22 enables full front access during installation and maintenance. Any work can then be done from the front of the patch panel 22 as the connectors as in 28 are slid from the side of the patch panel 22 and do not need to be clipped from the back thereof (as is the case when mounting to conventional patch panels), thus significantly simplifying cable installation and management.

Still referring to FIG. 1, the patch panel 22 offers the added advantage of not compromising the density of network racks or cabinets as in 12 while offering increased port capacity. Labelling and management between the patch panel 22 and networking equipment 20, such as servers, are further simplified as the patch panel 22 can be mounted in substantially the same plane as the equipment 20, with the access to sockets (reference 62 in FIG. 4) of the connectors as in 28 being moved closer to the equipment 20. Shorter cabling is therefore used, thus resulting in overall cost savings and aesthetic benefits.

Although the present invention has been described hereinabove by way of specific embodiments thereof, it can be modified, without departing from the spirit and nature of the subject invention as defined in the appended claims.

We claim:

1. A patch panel for mounting to a telecommunications rack comprising a pair of spaced vertical rails, the patch panel comprising:
a base frame comprising a mounting plate for attachment to one of the pair of rails and upper and lower elongate brackets extending away from an edge of said mounting plate at an angle thereto, said upper and lower brackets substantially parallel and spaced to define an open-ended connector receiving slot therebetween;
at least one connector module, each of said at least one module comprising a plug receiving socket on a front face thereof, a latch arm on an upper surface thereof and a retaining rib on a lower surface thereof, wherein when said at least one connector module is positioned in said slot, said latch arm engages an inner edge of said upper bracket and said retaining rib engages an inner edge of said lower bracket thereby retaining said connector module within said slot; and
a cover comprising a locking mechanism for releasably locking to said base frame over said at least one connector module, said cover comprising at least one aperture on a front face thereof, each of said at least one aperture providing access to said plug receiving socket of a respective one of said at least one connector.
